(19) United States
(12) Patent Application Publication
(10) Pub. No.: US 2023/0074170 A1
(43) Pub. Date: Mar. 9, 2023

(54) SIDE GUSSET PAPER CONTAINER, METHOD FOR PRODUCING THE SIDE GUSSET PAPER CONTAINER AND USE OF THE SIDE GUSSET PAPER CONTAINER

(71) Applicant: Mettler Packaging LLC, Raynham, MA (US)

(72) Inventors: Marco Olk, Malborn-Thiergarten (DE); Matthias Manfred Abend, Beuren (DE)

(21) Appl. No.: 17/901,531

(22) Filed: Sep. 1, 2022

(30) Foreign Application Priority Data
Sep. 2, 2021 (EP) 21194672.8

(51) Int. Cl. B65D 30/20; B65D 33/10; B65D 30/08; B31B 70/88; B31B 70/16; B31B 70/86; B31B 70/26; B31B 70/62

(52) U.S. Cl. CPC B65D 31/10; B65D 33/105; B65D 31/02; B31B 70/88; B31B 70/16; B31B 70/864; B31B 70/266; B31B 70/628; B31B 70/261; B31B 2155/00

(57) ABSTRACT

A side gusset paper container in which in the region of the transition of the front wall to a first part of the container bottom region, there is a first pre-crease, and in which in the region of the transition of the rear wall into a second part of the container bottom region, there is a second pre-crease. Furthermore, the disclosure relates to a method for producing a side gusset paper container, in which at least one or a plurality of linear pre-creases are formed in the inner side of a paper web. Additionally, the disclosure relates to a use of the side gusset paper container according to the disclosure as a compost collecting and/or carrying container and/or as a fillable container which is self-standing in the unfilled state.

### BACKGROUND

### Technical Field

The present disclosure relates to a side gusset paper container such as a side gusset pouch or bag, a method for producing such a side gusset paper container and the use of the side gusset paper container according to the disclosure.

### Description of the Related Art

Transport containers made of paper have the advantage that they do not generally pollute the environment and can be easily recycled or decomposed, for example. As they are based on renewable raw materials, their energy use does not generally contribute to a deterioration of the carbon dioxide balance. However, practical handling in daily use usually requires such paper bags or pouches to be filled easily and without difficulty. Self-standing paper bags, which can be filled with both hands even when unfilled without the help of third parties, have so far had to have large dimensions and a block base. The production of the latter is material-intensive and often requires additional processing steps. Therefore, the present disclosure was based on the problem of providing paper pouches and bags that do not have the disadvantages of the prior art and in some cases are self-standing even in the unfilled state, irrespective of their size.

### BRIEF SUMMARY

Accordingly, a side gusset paper container such as a side gusset paper pouch and a side gusset paper bag has been found with a container bottom or a container bottom region, a front wall with an upper container edge and an inner and an outer container side and opposite longitudinal folding edges, a rear wall with an upper container edge and an inner and an outer container side and opposite longitudinal folding edges, and opposite first and second side walls, each with an upper container edge and an inner and an outer container side, containing respectively at least one, in some cases exactly one, side gusset. In the side gusset paper container according to the disclosure, the front wall, in some cases along a first folding edge, transitions in one piece into a first part of the container bottom region with a first outer edge, also the rear wall transitions in one piece, in some cases along a second folding edge, into a second part of the container bottom region with a second outer edge. According to the disclosure this side gusset paper container is provided in the region of the transition of the front wall into the first part of the container bottom region, in some cases in the region of the first folding edge, in some cases at the first folding edge, at least partially, in some cases fully, with a first pre-crease and is provided in the region of the transition of the rear wall into the second part of the container bottom region, in some cases in the region of the second folding edge, in some cases at the second folding edge, at least partially, in some cases fully, with a second pre-crease.

Furthermore, in an expedient embodiment it can be provided that the first side wall transitions, in some cases along a third folding edge, in one piece into a third part of the container bottom region, that the second side wall transitions, in some cases along a fourth folding edge, in one piece into a fourth part of the container bottom region and that in the region of the transition of the first side wall into the third part of the container bottom region, in some cases in the region of the third folding edge, in some cases at the third folding edge, at least partially, in some cases fully, a third pre-crease is provided and that in the region of the transition of the second side wall into the fourth part of the container bottom region, in some cases in the region of the fourth folding edge, in some cases at the fourth folding edge, at least partially, in some cases fully, there is a fourth pre-crease.

The first and second pre-creases and in some cases also the third and fourth pre-creases are preferably pre-prepared pre-creases.

A pre-crease is generally understood to involve creasing the paper with pre-creasing tools known to the person skilled in the art, for example embossing tools. By applying a pre-crease the paper is generally modified in such a way that a sharped-edged fold is ensured in subsequent folding processes. For example, a pre-crease can be produced by a so-called rotating creasing blade against a rubber shaft or base. Too much creasing can damage the paper and then cause the material to tear in the fold during production. Too little creasing can result in inaccurate folding. With a pre-crease a fold line is specified without the fold being made however.

In an expedient embodiment, the first and second folding edges and in some cases also the third and fourth folding edges represent folding edges applied subsequent to the region of the first, second, third and fourth pre-creases respectively.

### BRIEF DESCRIPTION OF THE SEVERAL VIEWS OF THE DRAWINGS

Further features and advantages of the disclosure are given in the following description, in which embodiments of the disclosure are explained by way of example with reference to schematic drawings, without thereby limiting the disclosure, in which

FIG. 1 shows a schematic front view of a blank of a first embodiment of the side gusset paper container according to the disclosure,

FIG. 2 shows a schematic front view of a blank of a second embodiment of the side gusset paper container according to the disclosure,

FIG. 3 shows a schematic front view of a blank of a third embodiment of the side gusset paper container according to the disclosure and

FIG. 4 shows a schematic front view of the inner side of a paper web for producing the side gusset paper container of the disclosure according to the first embodiment.

### DETAILED DESCRIPTION

Side gusset paper containers according to the disclosure achieve an underlying objective of the disclosure of providing a self-standing paper container, irrespective of size, particularly well, in which the first and the second pre-crease and in some cases also the third and the fourth pre-crease are formed on the inside of the container of the front wall and rear wall and optionally of the first side wall and second side wall.

In expedient embodiments of the side gusset paper container according to the disclosure, the upper container edge of the front wall is located below the upper container edge of the rear wall. A generic use is provided, for example, when a side gusset paper bag is carried by the carrier handles, so that the bottom of the bag points downwards. A side gusset paper container which is set up on a base to be self-standing and can be filled with both hands without the aid of a third party is also a generic use. The aforementioned embodiment of a side gusset paper container according to the disclosure enables a very material-saving production, in some cases from a one-piece blank.

For many applications, it has proved to be sufficient that the first part of the container bottom region of the side gusset paper container according to the disclosure forms a substantially rectangular base. Here the first part of the container bottom region preferably has a greater extension (A) away from the transition of the front wall to the first part of the container bottom region, in some cases from the first folding edge, than the second part of the container bottom region has an extension (B) away from the transition of the rear wall into the second part of the container bottom region, in some cases from the second folding edge, and in some cases to the extent that the upper container edge of the front wall lies below the upper container edge of the rear wall. In particular in this way, it can be ensured that the side gusset paper container according to the disclosure can be made in a material-saving manner from only one one-piece blank. In this way, in an advantageous embodiment of the side gusset paper container according to the disclosure it can be provided that the first part of the container bottom region covers the second part of the container bottom region at least partially, in some cases substantially fully. Hereby, among other things, a particularly tight and stable bottom design can be achieved. In a particularly advantageous manner the first part of the container bottom region extends substantially up to or adjacent to the transition of the rear wall into the second part of the container bottom region, in some cases container bottom region substantially up to or adjacent to the second folding edge.

Another particular advantage of the side gusset paper container according to the disclosure is also that the amount of adhesive required to form a tight container bottom region can be kept very low. This is achieved, for example, in that the first part of the container bottom region, in some cases exclusively, adjacent to the transition of the rear wall into the second part of the container bottom region, in some cases to the second folding edge, is joined, in some cases adhered, to the inside of the second part of the container bottom.

In the side gusset paper container according to the disclosure, as already explained above, front wall, rear wall, first side wall and second side wall and first, second, third and fourth part of the container bottom region are preferably in one piece.

The first part of the container bottom region of the side gusset paper container according to the disclosure is preferably single layered or is mostly ingle layered. This also contributes to saving material during production.

In this connection also such side gusset paper containers according to the disclosure are advantageous in which the second part of the container bottom region substantially no longer forms or covers more than half the area or substantially half the area of the container bottom region.

With such side gusset paper containers according to the disclosure particularly advantageous production can generally be achieved, as well as handling, in which the distance of the first outer edge to the first pre-crease is substantially in the region of half the width up to the width of the first and/or second side wall. Hereby, alternatively and in some cases additionally, it can be provided that the distance of the second outer edge to the second pre-crease is substantially in the region of a third of the width up to two thirds of the width of the first and/or second side wall, preferably substantially in the region of half of the width of the first and/or second side wall.

In a further expedient embodiment, the side gusset paper container according to the disclosure has a first carrier handle, in some cases paper carrier handle, attached to the front wall, in some cases to the inner wall of the container of the front wall and/or, in some cases and, via a second carrier handle, in some cases a paper carrier handle, attached to the rear wall, in some cases to the inner container wall of the rear wall. Such a side gusset paper container is regularly referred to as a side gusset bag. If the side gusset paper container according to the disclosure does not have any carrier loops or carrier handles and also does not have handle holes, it can generally be referred to as a side gusset bag.

In order to obtain side gusset bags according to the disclosure, by which large carrying loads can be transported, at least one reinforcing layer can be provided in the attachment region of the carrier handles to the front wall and/or, in some cases and, at least one reinforcing layer can be provided in the attachment region of the carrier handles to the rear wall.

The paper used for the side gusset paper container according to the disclosure has in a particularly suitable embodiment a grammage in the range of 30 g/m² to 120 g/m², preferably in the range of 40 g/m² to 90 g/m².

Furthermore, in an expedient embodiment of the side gusset paper container according to the disclosure, it can be provided that the paper of the front wall, rear wall, first side wall and second side wall and of the first, second, third and fourth part of the container bottom region is laminated on the inside and/or outside or provided with a sealing lacquer. With such side gusset paper containers according to the disclosure also moist objects can be transported and stored. For example, such side gusset paper containers can be used as compost collection and/or carrying containers.

Particularly expedient embodiments of the side gusset paper container according to the disclosure further comprise a transverse fold line or transverse folding edge, which extends in the region of the first part of the container bottom region spaced apart from the first outer edge, in some cases substantially parallel or parallel to the first outer edge, in some cases in the region between the first and second side walls. Such an embodiment of the side gusset paper container according to the disclosure is particularly expedient, in which the transverse fold line or transverse folding edge in the region of the first part of the container bottom region spaced apart from the first outer edge, in some cases substantially parallel or parallel to the first outer edge, and in the region of the second part of the container bottom region spaced apart from the second outer edge, in some cases substantially parallel or parallel to the first outer edge, and in the region of the third part of the container bottom region spaced apart from the second outer edge, in some cases substantially parallel or parallel to the first outer edge, and in the region of the fourth part of the container bottom region spaced apart from the second outer edge, in some cases substantially parallel or parallel to the first outer edge, in some cases continuously. The embodiment described above results in particularly tight container bottoms.

The underlying objective of the disclosure is further achieved by a method for producing a side gusset paper container, in particular according to the disclosure, comprising the steps, in some cases in the shown sequence:
providing an, in some cases continuous, paper web with an inner and an outer side and with a first side edge and an opposite second side edge and a longitudinal extension,
providing an embossing tool,
providing a perforation tool,
transferring at least a portion of the paper web to a substantially planar, in some cases substantially non-yielding, base, so that the outer side faces the base,
introducing one or more linear pre-creases, extending substantially from the first to the second side edge or from the first to the second side edge, in some cases continuously, in some cases at a right angle or substantially at a right angle to the longitudinal extension of the paper web, into the inner side of the paper web with the embossing tool,
optionally providing a first and/or second carrier handle, in some cases on the inner side of the paper web spaced apart from the linear pre-crease,
providing a first perforation line (209) extending from the first to the second side edge, in some cases continuously, and not causing any separation, and
   providing a second perforation line extending from the first to the second side edge, in some cases continuously, at a distance from the first perforation line causing no separation, forming a blank base shape for the side gusset paper container, wherein the linear pre-crease is closer to the first than to the second perforation line,
forming longitudinal folding edges to obtain front wall, rear wall and first and second side wall and simultaneous or prior or subsequent formation of the side gussets of the first and second side wall, and
   overlapping merging of the first and second side edge of the paper web to form a tube and joining, in some cases gluing, the first and second side edge in the region of the overlap,
optionally laying the front wall and rear wall and the halves of the first side wall along the side gusset and the halves of the second side wall along the side gusset flat against one another,
separating the first and second perforation lines to obtain a side gusset paper container base body and
folding, in some cases folding over, a part of the section between the linear pre-crease and the first perforation line, in some cases forming the container bottom region, along a transverse fold line, onto the remaining part of the container bottom region or a part thereof forming an overlapping region and joining, in some cases gluing, the folded over part in the overlapping region with the remaining part.

The steps of introducing one or a plurality of linear pre-creases and the application of first and second perforation lines and optionally attaching the first and/or second carrier handle can be carried out sequentially in any sequence or also at the same time. It is also possible to perform two steps simultaneously in pairs.

In a further development of the method according to the disclosure this further subsequently comprises the step of forming the container bottom region by folding along the linear pre-crease. This step is generally carried out by the user of the side gusset paper container according to the disclosure. By providing the pre-crease or pre-creases, particularly if present on the inside of the container, a self-standing pouch bag or self-standing bag can be obtained particularly reliably by forming folding edges in the bottom region.

In one embodiment, the formation of longitudinal folding edges to obtain the front wall, rear wall and first and second side wall and the formation of the side gussets of the first and second side wall can temporally precede the overlapping merging of the first and second side edge of the paper web forming a tube and joining the first and second side edge. These two method steps can be carried out, particularly in the case of machine processing, substantially at the same time. In principle, it is also possible to precede the step of overlapping merging the first and second side edge of the paper web by forming a tube and joining the first and second side edge in the region of overlap with the step of forming longitudinal folding edges and side gussets.

Furthermore, the underlying objective of the disclosure is achieved by a side gusset paper container, obtained or obtainable according to the method according to the disclosure.

With the side gusset paper containers according to the disclosure, it is surprisingly possible to provide size independent self-standing containers, even in the unfilled state, which do not depend on the use of plastic, leather or textile layers or the joint use of a support structure. Furthermore, it was surprisingly found that the side gusset paper container according to the disclosure has a uniform low thickness in the flat, stackable state, for example also compared to block bottom bags. This can be attributed to the fact that in the flat, stackable state of the side gusset paper containers according to the disclosure, as initially obtained in the manufacturing process, the container bottom as such is not yet formed and therefore cannot bulk up. Rather, there is a container bottom region with, in the folded state, opposite areas which merge into front and rear wall respectively into first and second side wall. In contrast, in block bottom bags the fully folded container bottom is already fully formed at the end of the production process. This regularly leads to the fact that when stacking block bottom bags, the end with the folded bottom region is raised, which is a hindrance for transport and storage. This can only be avoided by turning each successive block bottom bag in a stack by 180°. With the side gusset paper container according to the disclosure such a time-consuming stacking process is no longer necessary.

FIG. 1 shows a first embodiment of a side gusset paper container (1) according to the disclosure, or of a blank for such a side gusset paper container (1) according to the disclosure, with a container bottom region (20), a front wall (2) with an upper container edge (21) and an inner and outer container side (23, 23′), a rear wall (4) with an upper container edge (41), an inner container side (43, 43′) and an outer container side (44, 44′) and a first side edge (203) and a second side edge (205), opposite first and second side walls (11, 11′), each with an upper container edge (13, 13′), an inner and outer container side (15, 15′) and a width (X), each including at least one side gusset (17, 17′), longitudinal fold edges (19, 19′) between the side walls (11, 11′) and the front wall (2) or the rear wall (4), an overlapping region (91) extending from the second side edge (205) in the direction of the longitudinal fold edge (19′) for joining the sections forming the rear wall, a transverse fold edge or line (81), and a carrier handle (71). In the shown embodiment, the rear wall (4) is formed by two sections (43, 44) of substantially the same size.

In the shown embodiment, the upper container edge of the front wall (21) lies below the upper container edge of the rear wall (41). The front wall (2) transitions along a first pre-crease (61) in one piece into a substantially rectangular first part (27) of the container bottom region (20) with a first outer edge (51) and a width or extension (A). The rear wall (4) transitions in one piece along a second pre-crease (63, 63′) into the sections forming the rear wall into a second part of the container bottom region (29, 29′) with a second outer edge (53, 53′) and a width or extension (B). The first side wall (11) transitions along a third pre-crease (65) in one piece into a third part (31) of the container bottom region, and the second side wall (11′) along a fourth pre-crease (65′) in one piece into a fourth part (31′) of the container bottom region. The first part (27) of the container bottom region has a larger extension (A) away from the first pre-crease (61) than the second part (29, 29′) of the container bottom region away from the second pre-crease (63, 63′).

In the finished set up fillable bag, the first folding edge (25) is at the first pre-crease (61), the second folding edge (45, 45′) is in the region of the second pre-crease (63, 63′), the third folding edge (55) is in the region of the third pre-crease (65), and the fourth folding edge (55′) is in the region of the fourth pre-crease (65′). By providing the pre-creases, a paper bag is obtained which, as soon as folding edges are formed along the prebridge when forming the bottom, is self-standing even in the unfilled state and can be filled with both hands without the help of a third party, and in some cases also with small container sizes, e.g., with a width of the front and rear wall in the region of 15 to 20 cm.

In the shown embodiment of the side gusset paper container (1) according to the disclosure, the transverse folding edge or line (81) extends continuously over the front wall, rear wall and first and second side wall, i.e., between the first side edge (203) and the opposite second side edge (205). Hereby, the transverse folding edge or line (81) is spaced more closely to the outer second outer edge (53, 53′) of the sections forming the second part (29, 29′) of the container bottom region (20) than to the first outer edge (51) of the first part (27) of the container bottom region (20). By folding over the portion lying below the transverse folding edge or line (81) of the bag folded and joined along the overlapping region (91) onto the overlying portion of the container bottom region (20) and gluing in the overlapping region, a particularly tight container bottom is obtained.

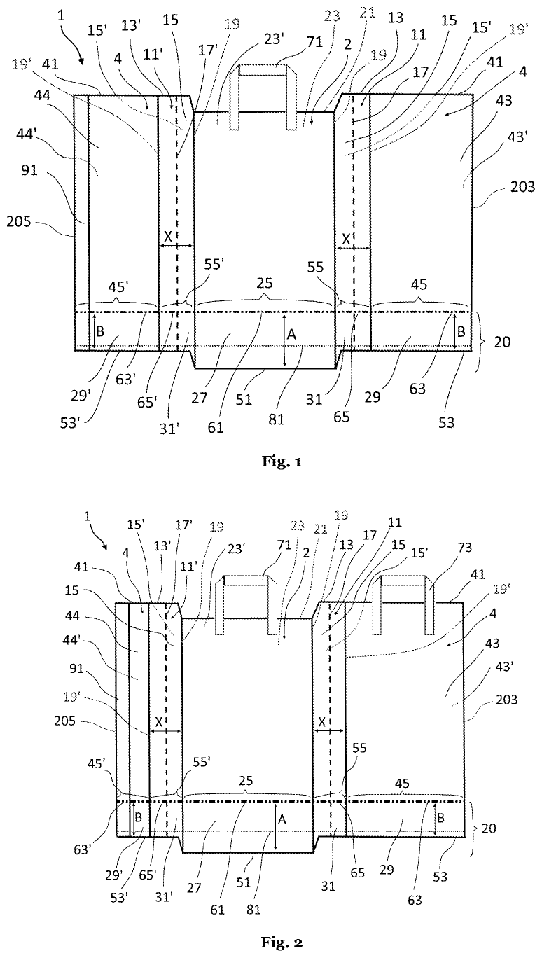

FIG. 2 shows a second embodiment of a side gusset paper container (1) according to the disclosure or of a blank for such a side gusset paper container (1) according to the disclosure which differs from the first embodiment shown in FIG. 1 in that the sections forming the rear wall (4) have a different size. In this way it is possible to attach both carrier handles (71, 73) to the still flat spread out paper web, in some cases substantially simultaneously, at a very early stage of the manufacturing process of the side gusset paper container (1) according to the disclosure.

FIG. 3 shows a third embodiment of a side gusset paper container according to the disclosure (1) or of a blank for such a side gusset paper container (1) according to the disclosure. This differs from the first embodiment shown in FIG. 1 as well as from the second embodiment shown in FIG. 2 in that the transverse fold edge or line (81) is located substantially only in the first part (27) of the container bottom region and extends parallel spaced apart from the first outer edge (51) between the two opposite longitudinal fold edges (19, 19′).

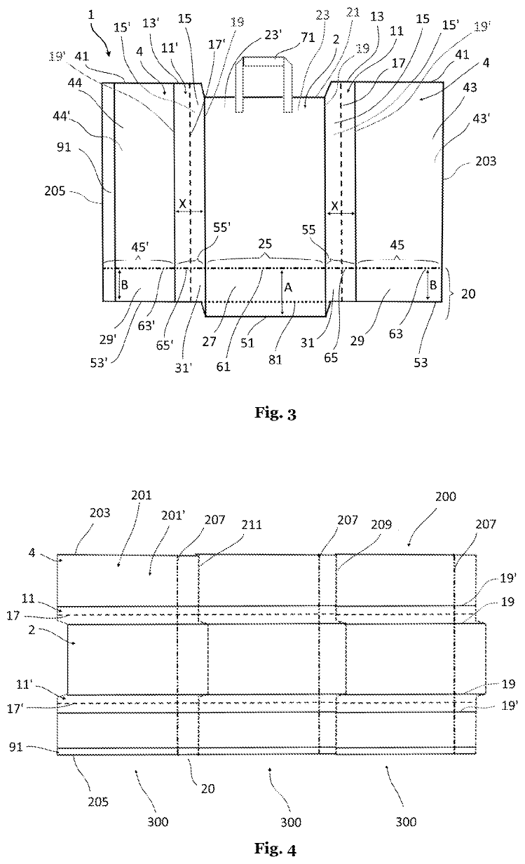

FIG. 4 shows a schematic front view of a paper web (200) for producing side gusset paper containers (1) according to the disclosure with an inner and outer side (201, 201′), a container bottom region (20), a front wall (2), two sections forming the rear wall (4), a first side edge (203) and an opposite second side edge (205), sections which form the first and the second side wall (11, 11′), each containing a side gusset (17, 17′) and an overlapping region (91) for the permanent connection to the side edge (203). Furthermore, longitudinal fold edges (19, 19′), a first perforation line (209), a second perforation line (211) and linear pre-creases (207) are provided. A side gusset paper container base body (300) for forming a side gusset paper container (1) according to the disclosure can be obtained by separating along the first and second perforation lines (209, 211).

The features of the disclosure disclosed in the above description, in the claims and in the drawings, may be essential both individually and in any combination for the implementation of the disclosure in its various embodiments.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A side gusset paper container, comprising:
a container bottom region,
a front wall with an upper container edge and an inner and outer container side and opposite longitudinal folding edges,
a rear wall with an upper container edge and an inner and outer container side and opposite longitudinal folding edges,
opposite first and second side walls, each with an upper container edge and an inner and outer container side, each containing at least one side gusset,
wherein the front wall, in particular along a first folding edge, transitions in one piece into a first part of the container bottom region with a first outer edge,
wherein the rear wall, in particular along a second folding edge, transitions in one piece with a second part of the container bottom region with a second outer edge, and
wherein:
in the region of the transition of the front wall to the first part of the container bottom region, in particular in the region of the first folding edge or on the first folding edge, at least partially, in particular fully, there is a first pre-crease, and
in the region of the transition of the rear wall into the second part of the container bottom region, in particular in the region of the second folding edge or on the second folding edge, at least partially, in particular fully, there is a second pre-crease.

2. The side gusset paper container according to claim 1, wherein:
the first side wall, in particular along a third folding edge, transitions in one piece into a third part of the container bottom region,
the second side wall, in particular along a fourth folding edge, transitions in one piece into a fourth part of the container bottom region,
in the region of the transition of the first side wall to the third part of the container bottom region, in particular in the region of the third folding edge or at the third folding edge, at least partially, in particular fully, there is a third pre-crease, and
in the region of the transition of the second side wall into the fourth part of the container bottom region, in particular in the region of the fourth folding edge or at the fourth folding edge, at least partially, in particular fully, there is a fourth pre-crease.

3. The side gusset paper container according to claim 1, wherein the first and the second pre-crease and in particular also the third and the fourth pre-crease represent pre-prepared pre-creases and/or, in particular and, and wherein the first and second folding edges and in particular also the third and fourth folding edges represent folding edges formed subsequently in the region of the first, second, third and fourth pre-creases respectively.

4. The side gusset paper container according to claim 1, wherein the first and the second pre-crease and in particular also the third and the fourth pre-crease are on the container inside of the front wall and rear wall and optionally of the first side wall and second side wall.

5. The side gusset paper container according to claim 1, wherein during use, the upper container edge of the front wall lies below the upper container edge of the rear wall.

6. The side gusset paper container according to claim 1, wherein the first part of the container bottom region forms a substantially rectangular base area.

7. The side gusset paper container according to claim 5, wherein the first part of the container bottom region has a greater extension away from the transition of the front wall into the first part of the container bottom region, in particular from the first folding edge, than the second part of the container bottom region having an extension away from the transition of the rear wall into the second part of the container base region, in particular from the second folding edge.

8. The side gusset paper container according to claim 1, wherein the first part of the container bottom region covers the second part of the container bottom region at least partially, in particular substantially fully.

9. The side gusset paper container according to claim 1, wherein the first part of the container bottom region extends substantially up to or adjacent to the transition of the rear wall into the second part of the container base region, in particular to the second folding edge.

10. The side gusset paper container according to claim 1, wherein the first part of the container bottom region, in particular exclusively, is joined, in particular glued, adjacent to the transition of the rear wall to the second part of the container bottom region, in particular to the second folding edge, on the inside to the second part of the container bottom region.

11. The side gusset paper container according to claim 2, wherein the front wall, rear wall, first side wall, and second side wall and the first, second, third and fourth part of the container bottom region are formed in one piece.

12. The side gusset paper container according to claim 1, wherein the first part of the container bottom region is single layered or mostly single layered.

13. The side gusset paper container according to claim 1, wherein the second part of the container bottom region forms or covers substantially no more than half the area or substantially half the area of the container bottom region.

14. The side gusset paper container according to claim 1, wherein a distance of the first outer edge from the first pre-crease is substantially in the region of half the width to the width of the first and/or second side wall and/or wherein a distance of the second outer edge from the second pre-crease is substantially in the region of a third of the width to two thirds of the width of the first and/or second side wall, preferably substantially in the region of half the width of the first and/or second side wall.

15. The side gusset paper container according to claim 1, further comprising a first carrier handle, in particular paper carrier handle, attached to the front wall, in particular to the inner container wall of the front wall, and/or a second carrier handle, in particular paper carrier handle, attached to the rear wall, in particular to the inner container wall of the rear wall.

16. The side gusset paper container according to claim 15, further comprising at least one reinforcing layer in the region of the attachment of the first carrier handle to the front wall and/or at least one reinforcing layer in the region of the attachment of the second carrier handle to the rear wall.

17. The side gusset paper container according to claim 1, wherein the paper has a grammage in the range of 30 g/m² to 120 g/m², preferably in the range of 40 g/m² to 90 g/m².

18. The side gusset paper container according to claim 2, wherein the paper of the front wall, rear wall, first side wall and second side wall and of the first, second, third and fourth part of the container bottom region is laminated on the inside and/or outside or is provided with a sealing lacquer.

19. The side gusset paper container according to claim 1, wherein a transverse fold line extends:
in the region of the first part of the container bottom region spaced apart from the first outer edge, in particular substantially parallel or parallel to the first outer edge, in particular in the region between the first and second side walls, or which extends in the region of the first part of the container bottom region spaced apart from the first outer edge, in particular substantially parallel or parallel to the first outer edge, and
in the region of the second part of the container bottom region spaced apart from the second outer edge, in particular substantially parallel or parallel to the first outer edge, and
in the region of the third part of the container bottom region spaced apart from the second outer edge, in particular substantially parallel or parallel to the first outer edge, and
in the region of the fourth part of the container bottom region spaced apart from the second outer edge, in particular substantially parallel or parallel to the first outer edge, in particular continuously.

20. A method for producing a side gusset paper container, comprising:
providing an, in particular continuous, a paper web having an inner and outer side and having a first side edge and an opposite second side edge and also a longitudinal extension,
providing an embossing tool,
providing a perforation tool,
transferring at least a part of the paper web onto a substantially planar, in particular substantially non-yielding base, so that the outer side faces the base,
introducing at least one linear pre-crease extending substantially from the first to the second side edge or from the first to the second side edge, in particular continuously, in particular at a right angle or substantially at a right angle to the longitudinal extension of the paper web, into the inner side of the paper web with the embossing tool,
if necessary attaching a first and/or second carrier handle, in particular to the inner side of the paper web at a distance from the linear pre-crease,
providing a first perforation line extending from the first to the second side edge, in particular continuously, without causing any separation, and
providing a second perforation line extending from the first to the second side edge, in particular continuously, without causing any separation, at a distance from the first perforation line, forming a blank base shape for the side gusset paper container, wherein the linear pre-crease is closer to the first perforation line than the second.

21. The method according to claim 20, further comprising:
after the step of applying the first and second perforation line, in particular in this sequence,
forming longitudinal fold edges to obtain the front wall, rear wall and first and second side wall and the simultaneous or prior or subsequent forming of side gussets of the first and second side wall, and
bringing together the first and second side edge of the paper web so that they overlap with the formation of a tube and joining, in particular gluing, the first and second side edge in the overlapping region,
optionally, laying the front wall and rear wall and the halves of the first side wall along the side gusset and the halves of the second side wall along the side gusset flat against one another,
separating the first and second perforation lines to obtain a side gusset paper container base body, and
folding, in particular folding over, a part of the section between the linear pre-crease and the first perforation line, in particular the container bottom region, along a transverse fold line, onto the remaining part of the container bottom region or a part thereof, forming an overlapping region, and joining, in particular gluing, the folded over part in the overlapping region to the remaining part.

22. The method according to claim 20, wherein the transverse fold line extends:
in the region of the first part of the container bottom region spaced apart from the first outer edge, in particular substantially parallel or parallel to the first outer edge, in particular in the region between the first and second side walls, or in the region of the first part of the container bottom region spaced apart from the first outer edge, and
in the region of the second part of the container bottom region spaced apart from the second outer edge, in particular substantially parallel or parallel to the first outer edge, and
in the region of the third part of the container bottom region spaced apart from the second outer edge, in particular substantially parallel or parallel to the first outer edge, and
in the region of the fourth part of the container bottom region spaced apart from the second outer edge, in particular substantially parallel or parallel to the first outer edge, in particular continuously.

23. The method according to claim 20, further comprising forming a container bottom by folding along the linear pre-crease.

24. A side gusset paper container obtained or obtainable according to the method of claim 20.

25. A use of the side gusset paper container according to claim 1, as a compost collecting and/or carrying container, in particular compost carrying bag and/or as a fillable container which is self-standing in the unfilled state.
